(19) United States
(12) Patent Application Publication
(10) Pub. No.: US 2008/0147827 A1
(43) Pub. Date: Jun. 19, 2008

(54) Method And System For Synchronizing Operating Modes Of Networked Appliances

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/610,907

(22) Filed: Dec. 14, 2006

(51) Int. Cl. G06F 15/177

(52) U.S. Cl. 709/220

(57) ABSTRACT

A method is described for synchronizing operating modes of networked appliances. The method includes receiving a mode message associated with a first network appliance, the message including predefined mode information identifying a mode change of the first network appliance. The method also includes determining whether a second network appliance includes a mode that is configured to be responsive to the changed mode of the first network appliance. The method further includes detecting a current mode of the second network appliance. The method also includes determining whether the current mode of the second network appliance and the mode configured to be responsive to the changed mode of the first network appliance match. The method further includes providing for changing the mode of the second network appliance to the mode configured to be responsive to the changed mode of the first network appliance based on the determination

### RELATED APPLICATIONS

The subject matter of this application is related to U.S. patent application Ser. No. 11/555,248, titled “METHOD AND SYSTEM FOR ROUTING A MESSAGE OVER A HOME NETWORK” (Attorney Docket No. I407/US), filed on Oct. 31, 2006, and U.S. patent application Ser. No. 11/______, titled “METHODS AND SYSTEMS FOR ROUTING A MESSAGE OVER A NETWORK ” (Attorney Docket No. I473/US), filed on even date with this application, each of these related applications being commonly owned by the owner of this application, the entire disclosures of which are each here incorporated by reference.

### BACKGROUND

Computing is becoming more and more ubiquitous. Not only do personal computers (PCs), laptops, and handheld computing appliances have processors, but most audio/video equipment, appliances, automobiles, etc., have one or more processors as well. Many of these appliances have no display, or provide a display on the appliance that is small. Few appliances provide remote user interfaces. Integrating all this computing power has been a problem of interest for some time. For example a common home may include a television, a digital video recorder (DVR), a desktop computer, multiple kitchen appliances, a refrigerator, and a washer and dryer. Each of these appliances can be networked and each includes a processor.

However, a service or network appliance must be running or enabled in order for it to serve its purpose. Two problems arise from this requirement. First, if a service or a network appliance is not running it must be activated and enabled. This is often done manually. When there are a number of network appliances/services which have dependencies they all must be activated. Again this is often done manually. In some cases, such as home entertainment equipment, a network appliance may automatically start another network appliance. This is done today by a direct wired link between an initiating network appliance and an affected network appliance through sending a control signal directly to the affected network appliance. Some network appliances wakeup when they detect a request over a network. Finally, sensing network appliances such as motion detectors may automatically start and stop a service or network appliance such as lights. Again this is a direct connection specific interface and in that sense is much like an on/off switch.

Second, some network appliances and services stay on constantly or for specific time periods each day. This can be quite wasteful in a case where a network appliance is used sporadically and/or sparsely.

Accordingly, there exists a need for methods, systems, and computer program products for synchronizing operating modes of networked appliances.

### SUMMARY

In one aspect of the subject matter disclosed herein, a method is described for synchronizing operating modes of networked appliances, the method includes receiving a mode message associated with a first network appliance, the message including predefined mode information identifying a mode change of the first network appliance. The method also includes determining whether a second network appliance includes a mode that is configured to be responsive to the changed mode of the first network appliance. The method further includes detecting a current mode of the second network appliance. The method also includes determining whether the current mode of the second network appliance and the mode configured to be responsive to the changed mode of the first network appliance match. The method further includes providing for changing the mode of the second network appliance to the mode configured to be responsive to the changed mode of the first network appliance based on the determination

According to another aspect, a system is described for synchronizing operating modes of networked appliances. The system includes a network stack configured to receive a message associated with a first network appliance, the message including predefined mode information identifying a mode change of the first network appliance. The system also includes a mode manager configured to determine if the second network appliance includes a mode that is configured to be responsive to the changed mode of the first network appliance according to the mode information, detect a current mode of a second network appliance, determine if the current mode of the second network appliance and the mode configured to be responsive the changed mode of the first network appliance according to the mode information match, and provide for changing the mode of the second network appliance to the mode configured to be responsive to the changed mode of the first network appliance based on the determination.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating a method for synchronizing operating modes of networked appliances, according to an exemplary embodiment

FIG. 2 illustrates a system for synchronizing operating modes of networked appliances, according to an exemplary embodiment;

FIG. 3 illustrates a system for synchronizing operating modes of networked appliances, according to an exemplary embodiment;

FIG. 4 is a data flow diagram illustrating the flow of data for synchronizing operating modes of networked appliances, according to an exemplary embodiment;

FIG. 5 illustrates a system for synchronizing operating modes of networked appliances, according to an exemplary embodiment; and

FIG. 6 illustrates a system for synchronizing operating modes of networked appliances, according to an exemplary embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

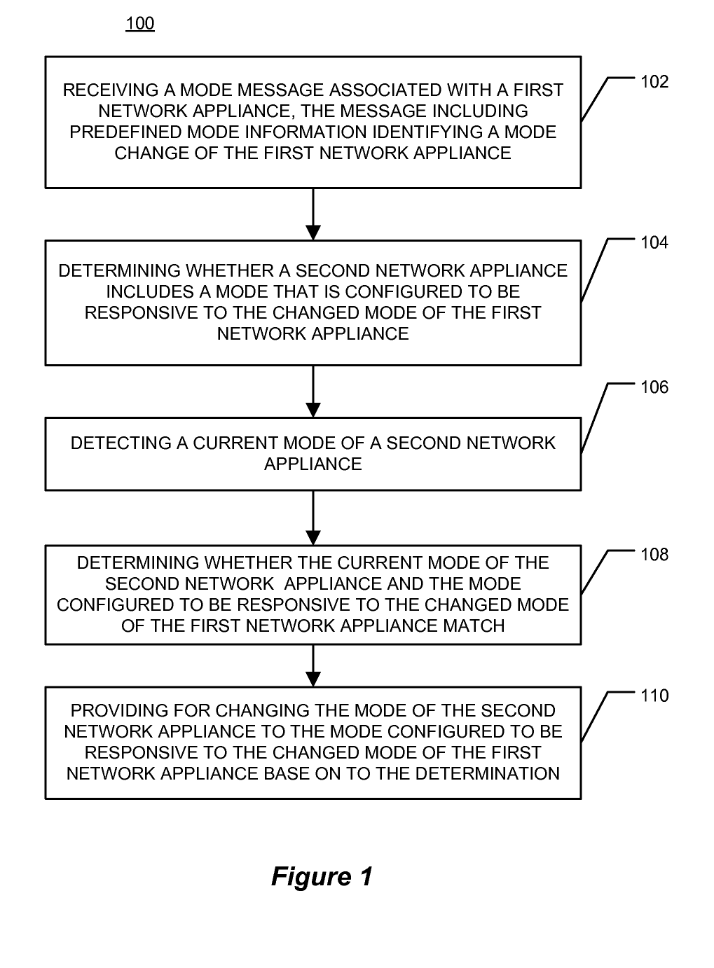

FIG. 1 illustrates a method 100 for synchronizing operating modes of networked appliances. The method allows one or more network appliances in a set of network appliances to automatically respond to a mode change in another network appliance of the set. It ensures that the network appliances' modes are synchronized allowing them to perform a service without requiring each network appliance to be manually put into a mode compatible with the desired service.

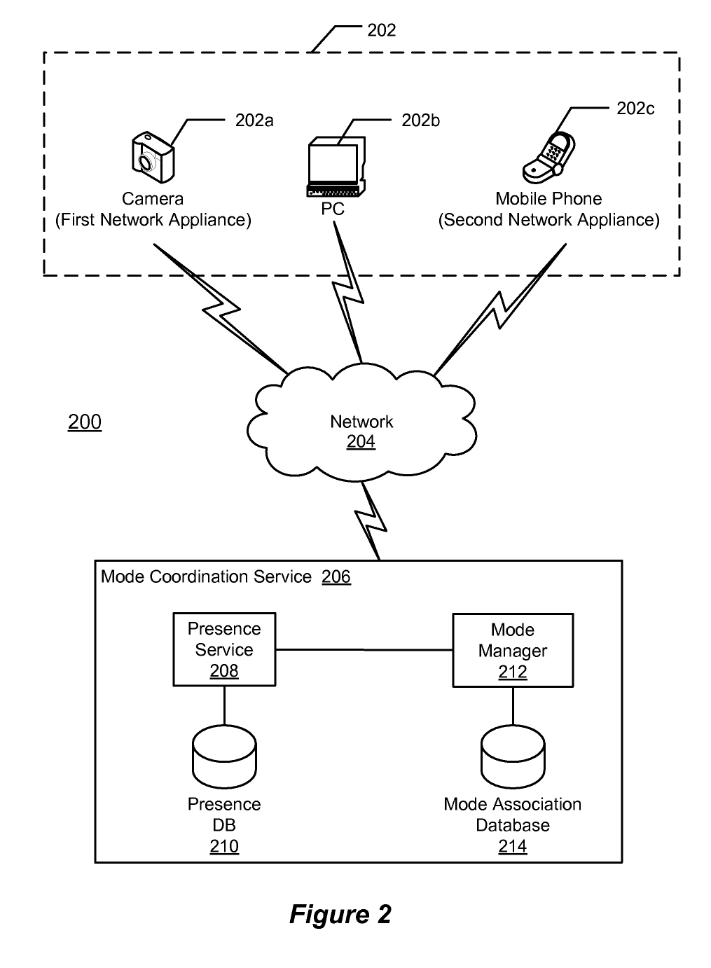

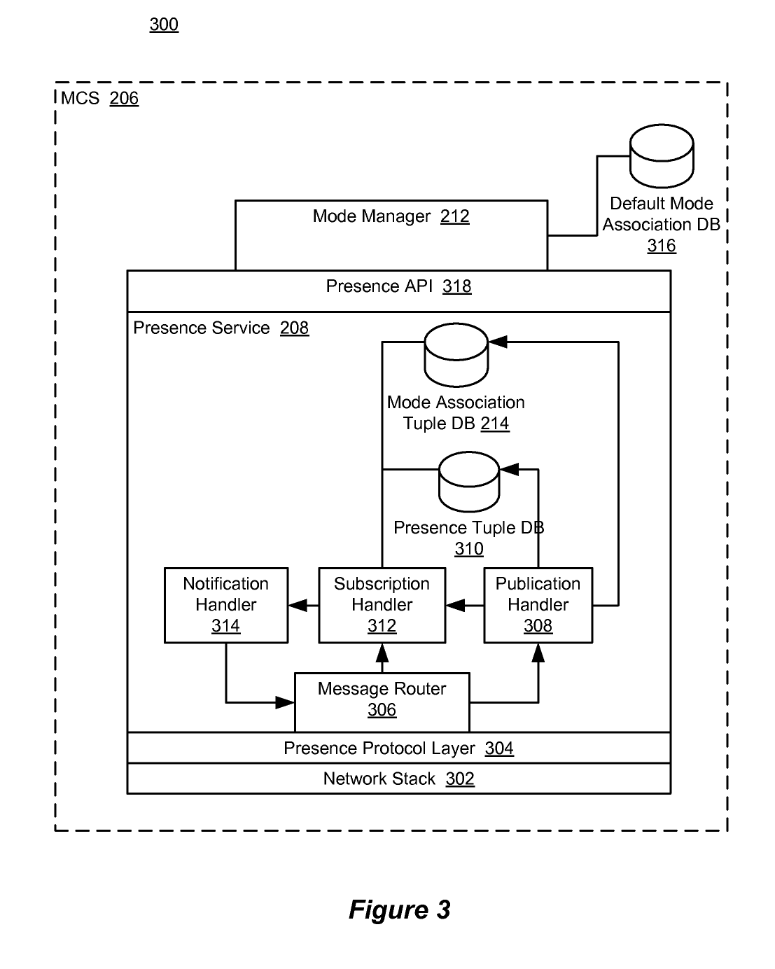

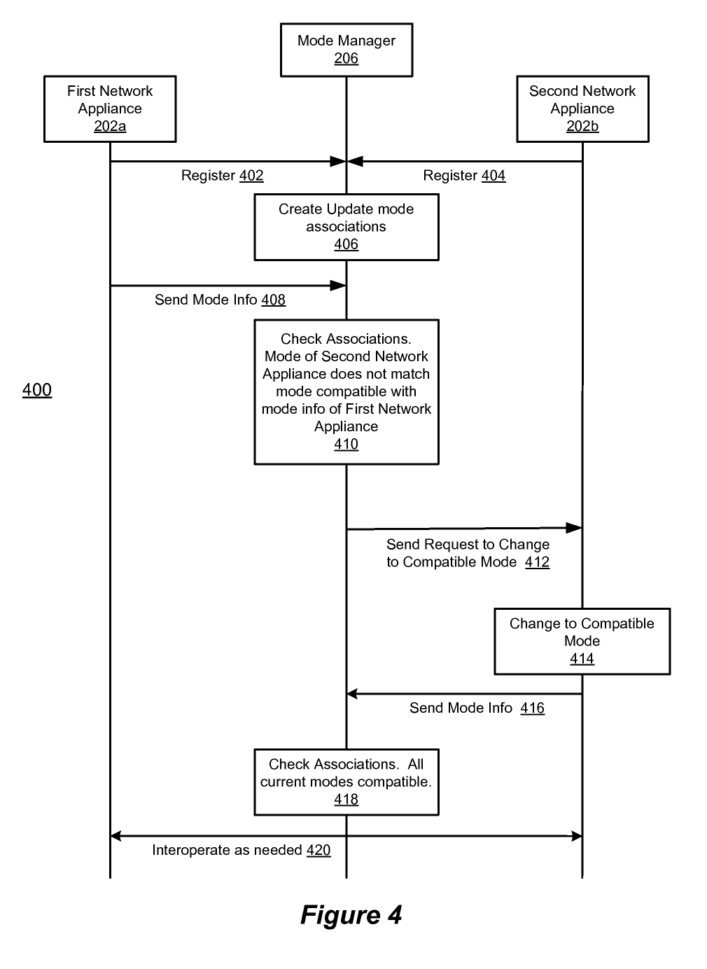

The method can be carried out using the exemplary system depicted in FIGS. 2 and 3, portions of which are referenced below for illustration purposes. FIG. 2 depicts an exemplary system 200 for performing the method 100 from a network level view. FIG. 3 depicts an exemplary server for managing the modes of network appliances, which is a component of the system 200 in one embodiment. FIG. 4 depicts an exemplary message flow 400 for illustrating an embodiment of the system 200 in which the server 300 is configured to perform the method 100 of FIG. 1.

The operation of method 100 is described in terms of the system 200 including the server 300 using the flow diagram 400 to illustrate an exemplary message flow.

Referring to FIG. 1, in block 102 of the method 100 a mode message associated with a first network appliance is received, the message including predefined mode information identifying a mode change of the first network appliance. As used herein, a mode of a network appliance, service, or a resource is defined by its current state, the activities the network appliance, service, or resource can engage in either actively and/or passively, and the states it may enter from its current state. Mode can be identified in a variety of ways. For example, mode in some embodiments is represented by a single value such as “on,” “off,” or “play.” In other embodiments, mode is represented by multiple values at any given time. For example, in some cases there is an overall mode indicator and a plurality of sub-mode or sub-state indicators. In still yet other embodiments, a specific mode indicator is not provided. An entity may implicitly determine the mode of a network appliance, service, or resource by monitoring events associated with the network appliance, service, or resources, that in some circumstances include an indicator of an operation that has been initiated, completed, or is still in progress. The term mode in this document is used interchangeably with state or operation, where the context makes the meaning clear.

An exemplary system for carrying out the method 100 of FIG. 1 includes means for receiving a mode message associated with a first network appliance, the message including predefined mode information identifying a mode change of the first network appliance. For example, FIG. 2 illustrates a set of exemplary network appliances including a digital camera 202a, a PC 202b, and a mobile phone 202c, collectively referenced as network appliances 202. The network appliances 202 are coupled to a network 204 that, in the embodiment shown, is a home network such as an Ethernet LAN, or an 802.x wireless network. In alternate embodiments, the network 204 can be an intranet of a business or other entity, the Internet, or a combination of the Internet and any number of intranets. Some embodiments isolate portions of the network 204 using a firewall (not shown) and in some of these cases, a proxy (not shown) can be used to allow communication with a network appliance protected by a firewall.

In the illustrated embodiment, the camera 202a receives an indication to connect to an external display for presenting captured images stored in the camera's 202a storage. In responding to the indication, the camera 202a sends a message including mode information that identifies the camera 202a has changed modes and/or is initiating a new operation.

Example 1 below illustrates an exemplary structure for at least a portion of a message including mode information.

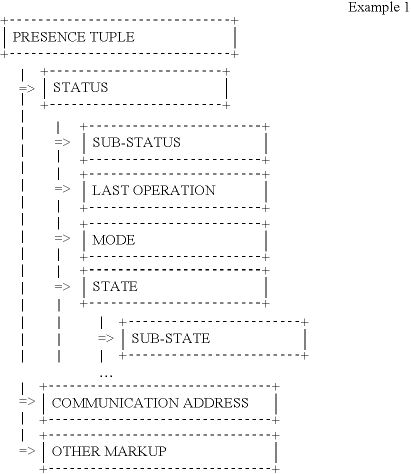

Depicted in the above example is a presence tuple conforming to the requirements of request for comments (or RFC) documents RFC 2778 to Day et al., titled A Model for Presence and Instant Messaging” (February 2000), and RFC 2779 to Day et al., titled “Instant Messaging/Presence Protocol” (February 2000), each published and owned by the Internet Society. The tuple includes a STATUS element that, in the embodiment shown, is multi-valued to illustrate a number of possible structures for representing mode information. The tuple includes a SUB-STATUS element that typically includes a value representing the overall status of the presentity of the network appliance, service, or resource. In accordance with the meaning of mode used here, this single value indicates the mode of its corresponding principal. A LAST OPERATION element includes an indicator of the initiation of the most recent operation, the status of an ongoing operation, and/or an indication of a recently completed operation. This element is at least a portion of a mode indicator in some embodiments. A MODE element is explicitly defined and used to indicate the mode of a network appliance, service, or resource. The value of the MODE element is single-valued in some embodiments and multi-valued in others. A STATE element is used in some embodiments where a network appliance, service, or resource is associated with a state model. State information relating to portions or subsystems of the network appliance, service, or resource is provided in some cases as represented by the SUB-STATE element of which there can be more than one. The exemplary elements can be used in combination to convey mode information, and those skilled in the art can see that other possible structures for supporting mode information can be constructed.

While Example 1 depicts a presence tuple and the described embodiment is described in terms of a presence system, the use of presence tuples, protocols, and/or servers is not required for carrying out the method 100 of FIG. 1. Alternate embodiments can use broadcast messages, a peer-to-peer protocol, or message relay server, for example. Further embodiments that use presence can include mode information in an element or elements outside the status element.

In the system 200, the mode message from the camera 202a is sent over the network 204 and is received by a mode coordination service (MCS) 206. The MCS 206 includes a presence service 208 that processes the publication of the message, updates a tuple associated with the camera 202a in a presence database 210, and sends notifications to subscribers. In one embodiment of the system 200, a mode manager is provided as a subscriber to a plurality of tuples associated with interoperative network appliances, services, and/or resources. As a result, the mode manager 212 receives notifications including mode information identifying a network appliance, service, or resource specific mode change.

The system 300 in FIG. 3 depicts the exemplary MCS 206 of the system 200 in greater detail, allowing a more thorough description of block 102 of the method 100 to be described. The mode message including the mode information is received via a network stack 302 where various protocol headers and trailers are processed and removed by layers of the network stack 302. The message without the network layer headers and trailers is passed to a presence protocol layer 304 for processing of a presence message, which can be a PUBLISH message in the case of the camera 202a sending mode information in the described presence-service-based embodiment.

The presence protocol layer 304 routes a representation of the message to the presence service 208 through a message router 306 of the presence service 208. Representations of the message will be referred to as the message here. Those skilled in the art will realize that as information included in the message is passed from one component to another, the format of the message can be altered. For example, non-critical information can be removed, and additional information needed by a particular component can be added. The message router 306 is configured to determine whether the mode message includes a publish message. For example the message router 306 detects the type of message, a PUBLISH command in the described embodiment, and routes the message based on the message type. In the case of a PUBLISH message, the message is sent to a publication handler 308 for processing.

The publication handler 308 can be configured to update a mode element of a presence tuple associated with the first network appliance with the predefined mode information in response to receiving the publish message. The publication handler 308 can be configured to create a presence tuple associated with the first network appliance in response to receiving the publish message. The presence tuple can include a mode element including the predefined mode information.

For example, the publication handler 308 determines whether an existing tuple associated with the sending presentity, the camera 202a, already exists in the presence tuple database 310. If a tuple exists, the publication handler 308 updates the contents of the tuple based on the message including the mode information. If the tuple does not exist, the publication handler 308 instructs the presence tuple database 310 to create a new tuple associated with the sending presentity and store information in the new tuple based on the message including the mode information. The publication handler 308 provides information to a subscription handler 312 associated with the tuple update or creation.

The subscription handler 312 is configured to locate a subscription list associated with the identified tuple. Subscription lists are stored in the presence tuple database 310 in the described embodiment, although they can be stored separately in other embodiments. In one embodiment, the mode manager 212 is automatically added as a subscriber to tuples in the presence tuple database 210 corresponding to network appliances, services, and/or resources. In another embodiment, a subscriber is determined based on information of one or more mode association tuples in the mode association tuple database 214.

For example, a mode association tuple in one embodiment includes a first network appliance identifier and mode information relating to the first network appliance and a second network appliance identifier. The mode association tuple indicates that the second network appliance has an association to the first network appliance when the first network appliance is in the mode identified by the mode information. When the camera 202a sends a message including mode information indicating that the camera 202a is in “network review” mode, a mode association tuple is locatable using the identifier of the camera 202a and the mode information in the associated presence tuple. The mode association tuple includes an identifier associated with the camera 202a, mode information associated with “network review” mode, and a second network appliance capable of participating in the network review operation, such as the PC 202b and/or mobile phone 202c.

Network appliance, service, and/or resource identifiers are specific to the network appliance, service, and/or resource in some embodiments. In an embodiment the identifiers are standard identifiers associated with a network appliance, service, and/or resource type and are provided as defaults by the mode manager 212 as depicted by the default mode association database 316. Network appliance, service, and resource providers include one or more appropriate standard identifiers in some of the messages generated by or on behalf of the network appliances, services, and/or resources. Similarly, modes are network appliance, service, and/or resource specific in some embodiments where other embodiments use agreed upon mode identification information. Whether a standard subscription list is used or a subscription is determined using a mode association tuple, the mode manager 212 is identified as a subscriber when the camera 202a sends a message received by the MCS 206 including mode information indicating that the camera 202a is in “network review” mode. Information identifying a subscriber is passed to a notification handler 314.

The notification handler 314 can be configured, in an embodiment, to generate a notification including the mode information. The notification is a representation of the mode information in the received mode message. In the embodiment described, the notification handler provides the notification to the mode manager 212. In another embodiment where the mode manager 212 receives notifications via a network interface, such as when the mode manager 212 operates in a different network appliance than the presence service 208, the notification handler 314 passes the notification to the message router 306. The message router 306 prepares the notification for transmission via the presence protocol layer 304, then invokes the presence protocol layer 304 for passing the notification. The presence protocol layer 304 uses the network address of the subscriber, the mode manager 212, to cause the network stack 302 to transmit the notification message over the network 204 to a network appliance supporting a compatible mode, such as PC 202b and/or mobile phone 202c, as indicated by one or more mode association tuples stored in the mode association tuple database 214.

In the system 300, the mode manager 212 is an application integrated into the MCS 206 and operatively coupled to the presence service 208 via a presence API 318. In this embodiment, the subscription information associated with the mode manager 212 indicates that notifications are communicated via the presence API 318. Thus, notification handler 314 passes the notification to the mode manager 212 using at least a portion of the API 318.

Although the described system 200 depicts a centralized system with an MCS 206 coordinating and synchronizing network appliance, service, and resource operating modes, a range of embodiments from centralized to pure peer-to-peer systems are capable of carrying out the method 100 of FIG. 1. In one example, the system 200 is reconfigured allowing the presence service 208 and the mode manager 212 to operate as separate services on separate network appliances. A network client system is described later in this document that is capable of supporting a pure peer-to-peer embodiment as well as a mixed peer-to-peer and centralized embodiment.

At block 104 of the method 100, a determination is made whether a second network appliance includes a mode that is configured to be responsive to the changed mode of the first network appliance. That is, a determination is made whether the second network appliances supports a mode that allows second network appliance to respond to the mode of the first network appliance as identified by the mode information.

An exemplary system for carrying out the method 100 of FIG. 1 includes means for determining whether a second network appliance includes a mode that is configured to be responsive to the changed mode of the first network appliance. For example, the mode manager 212 is configured to determine whether a second network appliance includes a mode that is configured to be responsive to the changed mode of the first network appliance. In an embodiment, the mode manager 212 uses the mode information in the notification to locate a network appliance, service, and/or resource that supports a mode which is compatible with the mode change of the first network appliance, the camera 202a. This information can be stored in a mode association tuple in the mode association tuple database 214. In another embodiment, the compatible network appliance, service, and/or resource information can be included in the received notification. The mode manager 212 determines a mode of a second identified network appliance, service, and/or resource that is compatible with the current mode of the first network appliance according to the information. For example, the mode manager 212 determines that the PC 202b supports an “auxiliary input” mode that is compatible with the camera's 202a “network review” mode.

At block 106 of the method 100, a current mode of the second network appliance is detected. An exemplary system for carrying out the method 100 of FIG. 1 includes means for detecting a current mode of the second network appliance. For example, in the system 200, the mode manager 212 is configured to detect a current mode of the second network appliance. The mode manager 212 can fetch the mode information from the tuple of each compatible network appliance, such as the PC 202b and/or the mobile phone 202c. In an alternate embodiment, the mode manager 212 may query the second network appliance for the mode information. The mode manager queries the second network appliance in many embodiments described here, including those not using a presence service. For example, the mode manager can be a peer mode manager in the first network appliance. In this embodiment, the peer mode manager is configured to query the second network appliance for the current mode of the second network appliance.

In still yet another embodiment, the detection can be performed by the second network appliance after receiving a message from the mode manager including mode information from the message sent from or on behalf of the first network appliance, service, and/or resource. This may be performed by the second network appliance in at least some embodiments using a peer-to-peer architecture.

At block 108 of the method 100 of FIG. 1, a determination is made whether the current mode of the second network appliance and the mode configured to be responsive to the changed mode of the first network appliance match. An exemplary system for carrying out method 100 includes means for determining whether the current mode of the second network appliance and the mode configured to be responsive to the changed mode of the first network appliance match. For example, the mode manager 212 is configured to determine whether the current mode of the second network appliance and the mode configured to be responsive to the changed mode of the first network appliance match. The mode manager 212 can make the determination by performing a match of the current mode of the second network appliance, such as PC 202b, with the mode of the second network appliance, the PC 202b, determined to be responsive to the changed mode of the first network appliance, the camera 202a. For example, if the current mode of the PC 202b is “offline” and the responsive mode of the PC 202b to the camera 202a in mode “network review” is “auxiliary input”, a comparison indicates the modes do not match.

In other embodiments, matching may be more complicated involving “lookups” to tables mapping network appliance, service, and/or resource specific modes to mode information from separate providers. A comparison using pre-specified mode information used by mode managers and network appliance, service, and resource providers is sufficient for many uses.

At block 110 of the method 100 of FIG. 1, changing the mode of the second network appliance to the mode configured to be responsive to the changed mode of the first network appliance based on the determination is provided for. An exemplary system for carrying out the method 100 includes means for providing for changing the mode of the second network appliance to the mode configured to be responsive to the changed mode of the first network appliance based on the determination. For example, the mode manager 212 is configured for changing the mode of the second network appliance to the mode configured to be responsive to the changed mode of the first network appliance based on the determination. The mode of the second network appliance is changed to the mode determined to be responsive to the changed mode of the first network appliance, if it is determined the current mode of the second network appliance is not a mode determined to be responsive to the changed mode of the first network appliance.

The mode manager 212 can be configured to transmit a change request message to the second network appliance, the change request message including mode change information identifying the mode configured to be responsive to the changed mode of the first network appliance. In an embodiment, the change request message is transmitted using a presence service.

In the example of the camera 202a with a mode changed to “network review” mode, when the current mode “offline” of the PC 202b doesn't match the mode “auxiliary input,” determined to be responsive to the “network review” mode of the camera 202a, the mode manager 212, in some embodiments, sends a command understandable by the second network appliance, the PC 202b, to affect a mode change in the second network appliance to the determined mode, “auxiliary input.” This particular example requires the PC 202b to be activated prior to being placed in the “auxiliary input” mode, illustrating that changing to a specified mode may require one or more mode changes to transition to the determined responsive mode. The determined mode “auxiliary input” is responsive to the first network appliance, the camera 202a, in its current mode “network review,” resulting from a mode change in the camera 202a. When the modes match, the mode manager 212 is not required to interact with the second network appliance, the PC 202b.

The command can be stored in a lookup table in some embodiments, while other embodiments can use pre-specified commands processed by mode managers and network appliances, services, and/or resources from various providers. In still yet another embodiment, the mode manager sends the determined responsive mode information to the second network appliance, the PC 202b, allowing the second network appliance to perform the necessary operations to affect the mode change. In some embodiments, network appliances, services, and resources may reject a mode change request or a command received to cause a mode change. In other embodiments, the mode manager 212 has complete authority. In one embodiment, the mode manager can be a peer mode manager associated with the second network appliance. In such an embodiment, the peer mode manager can be configured to activate the second network appliance.

In an embodiment, the method 100 of FIG. 1 can include receiving a feedback message associated with the second network appliance, the feedback message including change information identifying whether a change in mode of the second network appliance has occurred. The feedback message may be received using a presence service. To carry out this operation, the mode manager can be configured to receive a feedback message associated with the second network appliance. The feedback message can include change information identifying whether a change in mode of the second network appliance has occurred.

FIG. 4 is a flow diagram 400 illustrating a possible sequence of messages among the first network appliance, the camera 202a, an MCS 206, and the second network appliance, the PC 202b. The flow diagram reflects an embodiment with a server based MCS 206. Flow diagrams for peer-to-peer and mixed embodiments will differ, but are derivable by one skilled in the art given the description provided herein.

The message flow begins with both the first network appliance 202a and the second network appliance 202b registering with the MCS 206 by each sending register request messages 402 and 404, respectively. The registrants may register in any order, though the flow diagram 400 shows the registrations as simultaneous. A registration, if a presence server 208 is used, can be in the form of a request to create a tuple for a network appliance. The registration can include mode information that would trigger further activity by the MCS 206 as previously described. In the message flow described, the register messages 402 and 404 are not shown to include mode information to simplify the description of the message flow. Each registration causes the MCS 206 to determine whether a registrant should be associated with one or more mode association records in the mode association tuple database 214, as indicated by block 406. Once block 406 is performed, the MCS 206 waits for messages including mode information indicating a mode change.

The first network appliance 202a sends a message 408 including mode information that is received by the MCS 206. The MCS 206, using the mode information, determines in block 410 that the second network appliance 202b supports a mode that allows the second network appliance 202b to be responsive to the operation of the first network appliance 202a in its new mode, as identified in the mode information of the message 408. The MCS 206 also determines the current mode of the second network appliance 202b from the presence information of the second network appliance 202b via the presence service 208. By matching the current mode of the second network appliance 202b with the mode determined to be responsive to the operation of the first network appliance 202a, the MCS 206 determines the two modes do not match.

As a result of the determined mismatch, the MCS 206 generates and sends a message 412 including a command and/or at least a portion of the mode information received via the message 408 to the second network appliance 202b. The message 412 is received by the second network appliance 202b and processed in block 414. The processing causes the second network appliance 202b to change its mode to match the determined mode responsive to the operation of the first network appliance 202a given the mode information received by the MCS 206 in the message 408.

As a result of changing its own mode, the second network appliance 202b generates and sends a message 416. The message 416 includes mode information identifying the mode change affected by the processing at block 414. The message 416 is received by the MCS 206 and processed in block 418 in a manner analogous to the processing of the message 408 in block 410, except that the MCS 206 determines that all current modes are compatible with the change indicated by the mode information included in the message 416. The double arrow 420 in the diagram represents the two network appliances 202a, 202b operating in a manner where the second network appliance 202b is responsive to the operation of the first network appliance 202a.

A number of exemplary classes of alternative embodiments are outlined below. Embodiments are classified according to whether they use a centralized architecture as described in the embodiment, a peer-to-peer architecture, or a mixture of the two architectures, of which there are many variations. Embodiments can also be classified according to the communications techniques used to allow the various network appliances, services, and resources to communicate and/or be exchanged.

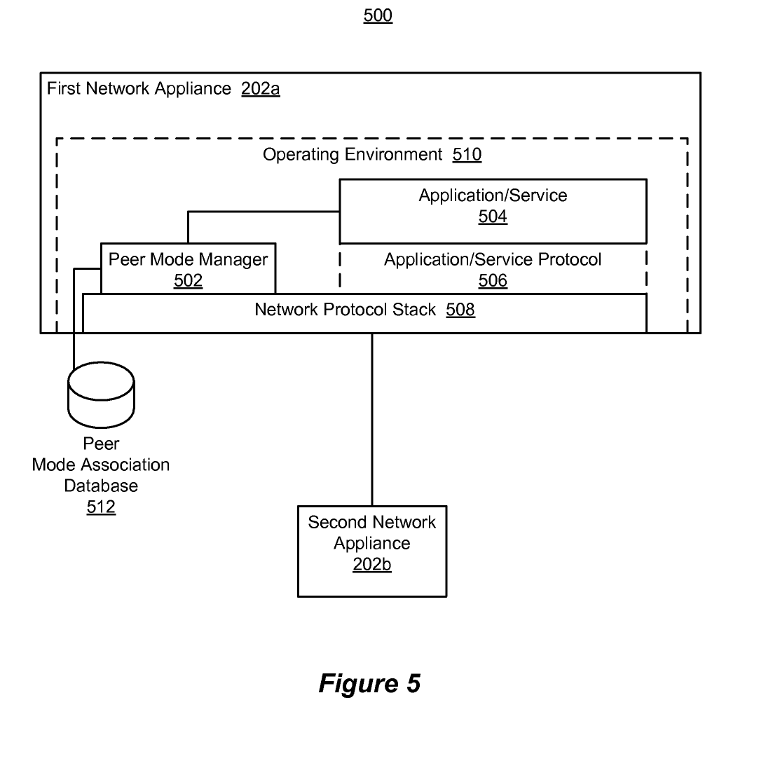

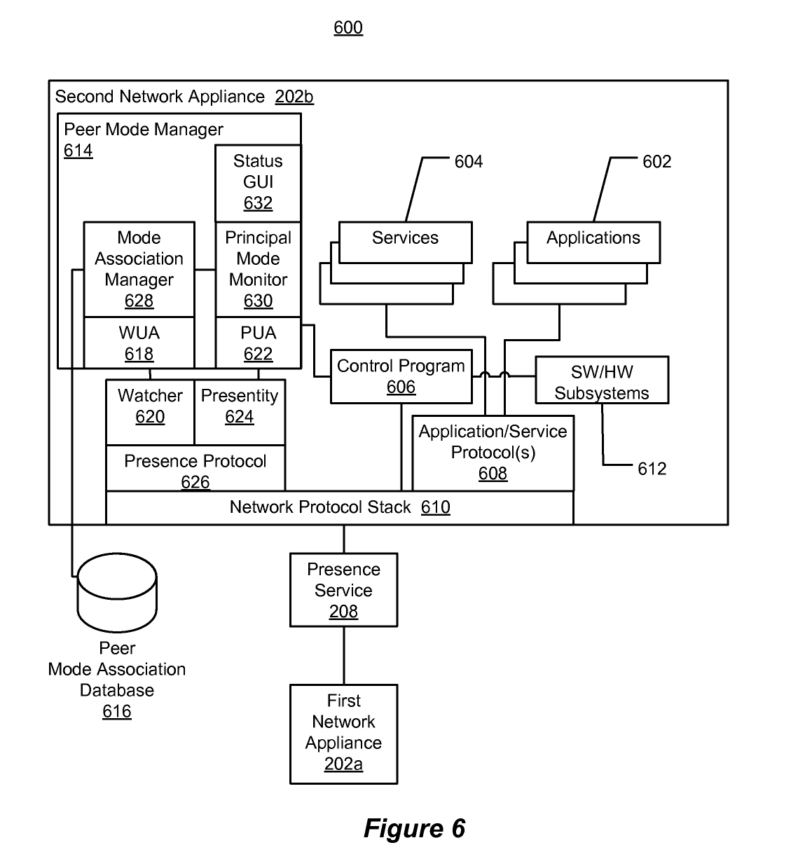

The system 500 in FIG. 5 depicts a network appliance in the role of a first network appliance described in accordance with the method 100 shown in FIG. 1. The system 500 can also act as a second network appliance, as will be seen by those skilled in the art. The system 600 in FIG. 6 is used to depict another embodiment of a network appliance, service, or resource in the role of a second network appliance as described in conjunction with the method 100, allowing for a description of alternate communication techniques.

The system 500 in FIG. 5 is an alternate embodiment of network appliances configured to support the methods described here. The camera 202a, the first network appliance, and the PC 202b, the second network appliance, of the system 200 can be configured to carry out the method 100 using system 500. A distinction between the system 500 and the system 200 is that the network appliances 202a and 202b include at least a portion of the function handled by the mode manager 212 of the system 200. This mode manager function is handled by the peer mode manager 502. In one embodiment of the system 500, described in detail below, no centralized mode manager is needed. Other embodiments employ a centralized mode manager 212 where the peer mode manager 502 provides a portion of mode manager function. Only network appliances, service, and resources having mode changes that cause mode changes in another network appliance, service, and/or resource require a peer mode manager 502. The remaining network appliances, services, and resources are configured to respond to commands from a peer mode manager.

A message including mode information identifying a mode change is provided to the peer mode manger 502 when an operation of the application or service 504 or one the other components of the first network appliance 202a, including the application/service protocol 506, the network protocol stack 508, or any other component or subsystem or operating environment 510, causes the mode change. The peer mode manager 502 determines if a second network appliance, service, and/or resource supports a mode that is responsive to the first network appliance 202a in its new mode identified by the mode information using the peer mode association database 512.

If such a network appliance, service, or resource is identified by the determination, such as the second network appliance 202b, the peer mode manager 502 may send a message to the second network appliance including mode information related to the determined responsive mode, allowing the second network appliance 202b to compare its current mode to the responsive mode identified in the message. If the modes do not match, the second network appliance 202b may change its current mode to match the indicated responsive mode.

In another embodiment, the peer mode manager 502 queries the second network appliance 202b for its current mode. This allows the peer mode manager 502 to perform the mode comparison described. If the modes do no match, the peer mode manager 502 sends one or more messages via the network protocol stack 508 to the second network appliance 202b to affect a mode change from the current mode to the responsive mode.

The system 600 in FIG. 6 depicts an exemplary second network appliance 202b including a plurality of applications 602, services 604, and/or resources (not shown) provided in an execution environment including an operating system or the control program 606, application and/or service specific protocols 608, if needed, a network protocol stack 610, and other software and hardware components and subsystems 612. Each application, service, and/or resource may be the source of a message including mode information or may be a target whose mode needs to be synchronized to a responsive mode with respect to one or more network appliances, services, and/or resources on the network including the second network appliance 202b.

Also depicted are a peer mode manager 614 and an associated peer mode association database 616 serving the need of the network appliance including its services 604, applications 602, and/or resources (not shown). The peer mode manager 614 may be configured to operate in a manner similar to the peer mode manager 502 of the system 500. The embodiment described with respect to the system 600, however, illustrates an embodiment driven mostly from a perspective of a network appliance, service, and/or resource of the second network appliance 202b described in conjunction with the method 100 of FIG. 1. That is, the second network appliance 202b mode is changed in response to a mode change of the first network appliance 202a.

The embodiment depicted uses a presence service 208 for monitoring modes of other network appliances and for communicating mode change information and requesting mode changes when required. Thus, the second network appliance 202b, using the peer mode manager 614, requires a watcher user agent (WUA) 618 and a watcher 620, a presence user agent (PUA) 622 and a presentity 624, and a presence protocol layer 626 enabling the peer mode manager 614 to communicate with the presence service 208. When an event causing a mode change is detected in the first network appliance 202a, a message including mode information relating to the change is sent to the presence service 208. The presence service 208 detects a subscription made by a mode association manager 628 via the WUA 618, the watcher 620, the presence protocol layer 626, and the network protocol stack 610 for the updated tuple associated with the first network appliance 202a including mode information. As a result of the subscription, the presence service 208 sends a notification to the peer mode manager 614 delivered by the same components used to subscribe to the tuple associated with the second network appliance 202b. The peer mode manager 614, using the mode association manager 628 and the data in the peer mode association database 616, determines whether it supports a mode that effectively causes the operation of the second network appliance 202b to be responsive to the operation of the first network appliance 202a in its identified mode. In the example described, the peer mode manager 614 determines that the second network appliance 202b has a mode that effectively causes the second network appliance to operate in a manner responsive to the first network appliance 202a in its new mode.

The peer mode manager 614 tracks the mode of the second network appliance 202b and its applications 602, services 604, and/or resources (not shown) via a principal mode monitor 630 in communication with control the program 606 to determine the mode information. Comparing the current mode information tracked with the responsive mode information, the peer mode manager 614 detects a mismatch. The peer mode manager 614, using the principal mode monitor 630, issues a command via the control program 606 to cause a mode change in the second network appliance 202b. This allows an appropriate service, application, and/or resource to operate in a manner that is responsive to the mode of the first network appliance 202a. The principal mode monitor updates its presence information by sending a message using the PUA 622, the presentity 624, the presence protocol 626, and the network protocol stack 610 to the presence service 208. The second network appliance 202b presents the updated mode information via a graphical user interface (GUI) enabling a user to see the mode information using a status GUI 632 of the peer mode manager 614. Those skilled in the art should see that equivalent functionality can be provided in embodiments not using a presence service and presence protocol.

The executable instructions of a computer program as illustrated in FIG. 1 for synchronizing operating modes of networked appliances can be embodied in any computer readable medium for use by or in connection with an instruction execution system, apparatus, or appliance, such as a computer based system, processor containing system, or other system that can fetch the instructions from the instruction execution system, apparatus, or appliance and execute the instructions.

As used here, a “computer readable medium” can be any means that can contain, store, communicate, propagate, or transport the program for use by or in connection with the instruction execution system, apparatus, or appliance. The computer readable medium can be, for example, but not limited to, an electronic, magnetic, optical, electromagnetic, infrared, or semiconductor system, apparatus, appliance, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for synchronizing operating modes of networked appliances, the method comprising:
receiving a mode message associated with a first network appliance, the message including predefined mode information identifying a mode change of the first network appliance;
determining whether a second network appliance includes a mode that is configured to be responsive to the changed mode of the first network appliance;
detecting a current mode of the second network appliance;
determining whether the current mode of the second network appliance and the mode configured to be responsive to the changed mode of the first network appliance match; and
providing for changing the mode of the second network appliance to the mode configured to be responsive to the changed mode of the first network appliance based on the determination.

2. The method of claim 1 comprising receiving a feedback message associated with the second network appliance, the feedback message including change information identifying whether a change in mode of the second network appliance has occurred.

3. The method of claim 2 wherein the feedback message is received using a presence service.

4. The method of claim 1 wherein receiving the mode message includes receiving a publish message via a presence service.

5. The method of claim 4 comprising updating a mode element of a presence tuple associated with the first network appliance with the predefined mode information in response to receiving the publish message.

6. The method of claim 4 comprising creating a presence tuple associated with the first network appliance in response to receiving the publish message, the presence tuple including a mode element including the predefined mode information.

7. The method of claim 1 wherein receiving the mode message includes receiving a notification identifying the first network appliance and the predefined mode information identifying the mode change of the first network appliance.

8. The method of claim 1 wherein determining whether a second network appliance includes a mode responsive to the first network appliance includes identifying the second network appliance using a mode association tuple, the mode association tuple including a first appliance identifier and mode information associated with the first appliance and a second appliance identifier associated with the mode information.

9. The method of claim 1 wherein detecting the current mode of the second network appliance includes retrieving mode information from a tuple associated with the second network appliance.

10. The method of claim 1 wherein detecting the current mode of the second network appliance includes querying the second network appliance for the current mode of the second network appliance.

11. The method of claim 1 wherein providing for changing the mode of the second network appliance includes activating the second network appliance.

12. The method of claim 1 wherein providing for changing the mode of the second network appliance includes transmitting a change request message to the second network appliance, the change request message including mode change information identifying the mode configured to be responsive to the changed mode of the first network appliance.

13. The method of claim 12 wherein the change request message is transmitted using a presence service.

14. A system for synchronizing operating modes of networked appliances, the system comprising:
a network stack configured to receive a message associated with a first network appliance, the message including predefined mode information identifying a mode change of the first network appliance;
a mode manager configured to determine if the second network appliance includes a mode that is configured to be responsive to the changed mode of the first network appliance according to the mode information, detect a current mode of a second network appliance, determine if the current mode of the second network appliance and the mode configured to be responsive the changed mode of the first network appliance according to the mode information match, and provide for changing the mode of the second network appliance to the mode configured to be responsive to the changed mode of the first network appliance according to the mode information based on the determination.

15. The system of claim 14 wherein the mode manager is configured to receive a feedback message associated with the second network appliance, the feedback message including change information identifying whether a change in mode of the second network appliance has occurred.

16. The system of claim 14 comprising a message router configured to determine whether the mode message includes a publish message.

17. The system of claim 16 comprising a publication handler configured to update a mode element of a presence tuple associated with the first network appliance with the predefined mode information in response to receiving the publish message.

18. The system of claim 16 comprising a publication handler configured to create a presence tuple associated with the first network appliance in response to receiving the publish message, the presence tuple including a mode element including the predefined mode information.

19. The system of claim 14 wherein the mode manager is configured to use a mode association tuple to determine whether the second network appliance includes a mode responsive to the first network appliance.

20. The system of claim 14 wherein the mode manager is configured to retrieve mode information from a tuple associated with the second network appliance to detect the current mode of the second network appliance.

21. The system of claim 14 wherein the mode manager is a peer mode manager associated with the first network appliance.

22. The system of claim 21 wherein the peer mode manager is configured to query the second network appliance for the current mode of the second network appliance.

23. The system of claim 14 wherein the mode manager is configured to transmit a change request message to the second network appliance, the change request message including mode change information identifying the mode configured to be responsive to the changed mode of the first network appliance, wherein the mode of the second network appliance can be changed.

24. The system of claim 14 wherein the mode manager is a peer mode manager associated with the second network appliance.

25. The system of claim 24 wherein the peer mode manager is configured to activate the second network appliance.

26. A system for synchronizing operating modes of networked appliances, the system comprising:
means for receiving a mode message associated with a first network appliance, the message including predefined mode information identifying a mode change of the first network appliance;
means for determining whether a second network appliance includes a mode that is configured to be responsive to the changed mode of the first network appliance;
means for detecting a current mode of the second network appliance;
means for determining whether the current mode of the second network appliance and the mode configured to be responsive to the changed mode of the first network appliance match; and
means for providing for changing the mode of the second network appliance to the mode configured to be responsive to the changed mode of the first network appliance based on the determination.

27. A computer readable medium containing a computer program, executable by a machine, for synchronizing operating modes of networked appliances, the computer program comprising executable instructions for:
receiving a mode message associated with a first network appliance, the message including predefined mode information identifying a mode change of the first network appliance;
determining whether a second network appliance includes a mode that is configured to be responsive to the changed mode of the first network appliance;
detecting a current mode of the second network appliance;
determining whether the current mode of the second network appliance and the mode configured to be responsive to the changed mode of the first network appliance match; and
providing for changing the mode of the second network appliance to the mode configured to be responsive to the changed mode of the first network appliance based on the determination.
